(19) United States
(12) Patent Application Publication
(10) Pub. No.: US 2026/0268914 A1
(43) Pub. Date: Sep. 10, 2026

(54) CODING OF GRANULAR SYNTHESIS DATABASES

(71) Applicant: Telefonaktiebolaget LM Ericsson (publ), Stockholm (SE)

(72) Inventors: Raksha RAMAKRISHNA, Vällingby (SE); Tommy FALK, Spånga (SE)

(73) Assignee: Telefonaktiebolaget LM Ericsson (publ), Stockholm (SE)

(21) Appl. No.: 19/166,826

(22) PCT Filed: Mar. 20, 2024
(86) PCT No.: PCT/EP2024/057409

§ 371 Date: Sep. 18, 2025

Related U.S. Application Data
(60) Provisional application No. 63/453,517, filed on Mar. 21, 2023.

(51) Int. Cl. G10L 19/00

(52) U.S. Cl. CPC G10L 19/00

(57) ABSTRACT

A method for decoding audio segments. The method includes obtaining an encoded representation (ER) corresponding to an original segment of an audio recording, wherein the ER comprises a prototype segment identifier. The method also includes obtaining a prototype segment, wherein obtaining the prototype segment comprises using the prototype segment identifier to retrieve the prototype segment. The method further includes using the prototype segment to reconstruct the original segment.

### TECHNICAL FIELD

Disclosed are embodiments related to audio coding.

### BACKGROUND

Audio rendering is a process used for presenting audio, such as audio within an extended reality (XR) scene (e.g., a virtual reality (VR), augmented reality (AR), or mixed reality (MR) scene) in order to give a listener the impression that sound is coming from physical sources within the scene at a certain position. The presentation can be made through headphone speakers or other speakers. If the presentation is made via headphone speakers, the processing used is called binaural rendering and uses spatial cues of human spatial hearing that make it possible to determine from which direction sounds are coming. The cues involve inter-aural time delay (ITD), inter-aural level difference (ILD), and/or spectral difference.

Procedural audio refers to the creation of sound in real-time as a response to live input. As an example, consider the sound of a car engine in a virtual space where the sound changes based on the speed or acceleration or the car. This mechanism is commonly used in video games for better user experience. It is believed that for the use case of XR (e.g., AR or VR), there are many sounds that would benefit from being dynamically generated so that they can react to changes in the scene in real-time. For example, the sound generated when a user touches a surface or operates an engine. In reference [1], sounds of a virtual object, for example a sword, axe, or wand, are simulated based on their position and orientation. There is a base tone and an overtone. Both are modulated to change pitch, timbre, amplitude to convey speed of movement of the virtual object. The live input may come from a user via sensors, such as hand controllers or a headset, it could be control data generated in real-time by some software process such as a physics simulation or pre-defined automation data. Regardless of how the input data was generated, the audio renderer needs to handle incoming data and generate sound in response to this data in real-time.

There exist many different methods for procedural audio, including synthetic sound synthesis using audio processing modules, machine learning methods trained on real recordings, and concatenative synthesis methods that make use of original recordings and rearrange grains of these recordings to generate variations. Because the class of concatenative synthesis methods makes direct use of real recordings, the generated audio sounds very natural thereby enhancing user experience.

Granular synthesis is a type of concatenative synthesis where a sound recording is divided into small fragments called “grains.” (See, e.g., reference [3]). By a careful selection of the fragments (grains) at rendering time, a plausible dynamically changing sound can be generated.

A granular synthesis process includes two main steps: (1) grain extraction and (2) grain synthesis. Grain extraction refers to extraction of pertinent grains from the original longer recording. The extraction method depends on the type of sound source and the desired features to be extracted. Grain synthesis refers to the technique of selecting the appropriate order of grains; this selection of the ordering could also be based on the user input in real-time.

Many sound design tools support grain extraction and synthesis, such as, for example Soundseed grain for Audiokinectic Wwise, Alchemy for Logic Pro or AudioMotors for FMOD. The tools allow for manual or semi-automated extraction of grains by the sound designer and other simple manipulations. The designer can choose the grain length, the amplitude envelope or shape of each grain among other controls. In the case of AudioMotors, an automated grain extraction tool specialized for motor sounds is provided.

Grain extraction can be done manually by the sound designer or in a data-driven manner by identifying the relevant features of the audio for fragmentation purposes. Relevant features include, for example, pitch period in the case of pitched sounds, spectral energy at a given frequency, mel-frequency cepstrum coefficients (MFCC), and local maxima of the amplitude envelope.

There are also many methods for granular synthesis. A common method is to select grains at random and perform overlap and add (OLA) operation. This method is not amenable to all types of sound sources and does not capture temporal correlation between adjacent grains.

### Background on Corpus-Based Concatenative Synthesis

Corpus-based concatenative synthesis (CBCS) methods are based on selecting grains from a corpus (i.e., a collection) of grains that are sampled from a database of heterogeneous grains. They utilize descriptors that are associated to grains to organize the corpus (a.k.a., database) and perform searches within the descriptor space to pick the next grain. Note that the concept of a descriptor is not limited to features of audio signal (see, e.g., reference [4]). A user can annotate grains with perceptual descriptors when a direct mapping between desired effect and feature in the audio signal is not possible.

The descriptor space is multi-dimensional with the number of dimensions being equal to the number of descriptors. Search for the appropriate grain is performed in a computationally efficient manner by utilizing weighted Euclidean distance between a target descriptor location (e.g., point or area) in the descriptor space (hereafter referred to as “target descriptor coordinate”) and grain locations in the descriptor space. Reference [5] proposes warping functions for the distance measure to better select the set of grains and also to avoid repetitions of previously rendered grains. For efficient search in the descriptor space, kD-tree search is used. Either k-nearest neighbors of the target descriptor coordinate or grains that are within a radius ‘r’ from the target descriptor coordinate are chosen. In reference [6], the corpus is organized as zones so that grains from different zones are not picked consequently when k-nearest neighbor search is used.

The software CATERPILLAR (see Reference [7]) performs concatenative synthesis in an offline setup where a sequence of target descriptors is given. The program uses Viterbi algorithm to identify the sequence of grains to match the target descriptors. The cost function is a combination of distance from target descriptor coordinate and concatenation cost which is based on similarity of consecutive grains. CataRT on the other hand is a real-time system and so it chooses the subsequent grain at random from a set of grains that are the k-nearest neighbors or a radius with the target descriptor coordinate being the center (see, e.g., reference [8]).

For smoother transitions in granularly synthesized sound, reference [9] uses feature descriptors like pitch, loudness, spectral centroid, fundamental frequency, periodicity, and autocorrelation coefficient at lag 1. Feature descriptors are computed for every grain and correlation among these feature descriptors is captured using a Gaussian Mixture Model (GMM) from which grains are sampled for synthesis. Reference [10] discusses granular synthesis where the next grain is picked based on feature descriptors of the current grain for a continuity in timbre. A kD-tree search is performed to select the candidate grains closest in Euclidean distance to the current grain in the feature descriptor space.

### Background on Audio Encoders

Given the creation of a database of grains (i.e., a collection of grains) where each grain has a location in a descriptor space, it is of interest to encode this database with as few bits as possible that allows for effective retrieval of the grains from the database. There is no specific work in the area of compression or encoding of audio databases. One could use existing compression techniques to encode all the individual grains separately.

Lossy or perceptual coding techniques for audio have been the subject of many standardization efforts. They use transforms such as the modified discrete cosine transform (MDCT) and encode the coefficients. Some well-known methods include MP3 and AAC.

Lossless audio codecs such as FLAC, ALAC, MPEG-4 ALS [11] can reconstruct the audio signal with no error or coding artifacts. However, they lead to lesser compression rates.

Audio compression techniques in general use linear prediction with memory to predict the sequence of samples and then encode the residual between the predicted and the actual samples. If this encoding of residuals is performed in a lossless manner, it is possible to perfectly reconstruct the original audio signal. If perceptual coding or lossy methods are instead used, they lead to distortions in the original audio signal when decoded.

Another alternative is use generic or media-agnostic compression techniques to encode the entire database of grains by treating them as files in a folder that is to be compressed. Many off-the-shelf algorithms exist for this use-case. Examples include Huffman coding, arithmetic coding, Lempel-Ziv (LZ-77, LZ-78, LZMA) compression.

### SUMMARY

Certain challenges presently exist. For instance, there are no specialized methods for encoding a database of grains. The use of audio-specific encoding methods for individual grains would lead to loss of coding efficiency as they would not use similarity or correlation amongst grains. On the other hand, off-the-shelf lossless encoding methods that are not intended for a particular type of media would also lead to inefficient coding. Perceptual audio coding methods may not be ideal since they introduce coding distortion that may not be perceptually transparent when grains are combined together. Problems may arise from phase cancellation within the overlapping regions of consecutive grains.

Because the grain schedule is not known during encoding (i.e., during encoding of grains in a database it is not known which of the grains will be selected for rendering), it is difficult to address the problem with phase cancellation beforehand. Furthermore, in procedural audio, any order or schedule of grains must be theoretically possible which means that methods need to be designed to foresee all the potential problems that arise from any combination of grains.

Existing audio coding methods typically are frame-based and use the previously encoded frame to predict the next one. In a granular database, there is no temporal aspect, and the most correlated grain may not be the one that was extracted one after another unless they were extracted from the same recording.

Existing lossless audio codecs like in MPEG-4 ALS, FLAC, ALAC etc. can be used to encode individual audio grains. However, grains may be correlated which means loss of efficiency when the grains are encoded individually.

Generic or media-agnostic coding methods such as Huffman coding, RICE coding LZ77 etc. could be used to encode granular database but they would not necessarily utilize audio specific idiosyncrasies for better compression rate.

Accordingly, in one aspect there is provided a method for decoding audio segments. In one embodiment, the method includes obtaining an encoded representation (ER) corresponding to an original segment of an audio recording, wherein the ER comprises a prototype segment identifier. The method also includes obtaining a prototype segment, wherein obtaining the prototype segment comprises using the prototype segment identifier to retrieve the prototype segment. The method further includes using the prototype segment to reconstruct the original segment.

In another aspect there is provided a method for encoding segments of an audio recording included in a collection of segments. In one embodiment, the method includes classifying a first segment included in the collection of segments as a prototype segment or classifying a modified version of the first segment as a prototype segment. The method also includes using the prototype segment (i.e., the first segment or the modified version of the first segment) to encode a second segment included in the collection of segments.

In another embodiment the method of encoding the segments includes, for a first segment in the collection, selecting a second segment in the collection that is similar to the first segment (e.g., comparing the first segment to each other segment in the collection to determine which one of the other segments is most similar to the first segment). The method also includes using the second segment to encode the first segment.

In another aspect there is provided an apparatus that is configured to perform the methods disclosed herein. The apparatus may include memory and processing circuitry coupled to the memory.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium.

An advantage of the embodiments disclosed herein is that they facilitate encoding a grain database without any loss of quality while also utilizing an underlying correlation amongst multiple grains to achieve a coding gain.

### BRIEF DESCRIPTION OF THE DRAWINGS

The accompanying drawings, which are incorporated herein and form part of the specification, illustrate various embodiments.

FIG. 1 illustrates a system for performing granular synthesis.

FIG. 2 illustrates an example two-dimensional descriptor space

FIG. 3 illustrates an encoding system according to an embodiment.

FIG. 4 illustrates an decoding system according to an embodiment.

FIG. 5 is a flowchart illustrating a process according to an embodiment.

FIG. 6 is a flowchart illustrating a process according to an embodiment.

FIG. 7 is a flowchart illustrating a process according to an embodiment.

FIG. 8 is a block diagram of an apparatus according to some embodiments.

### DETAILED DESCRIPTION

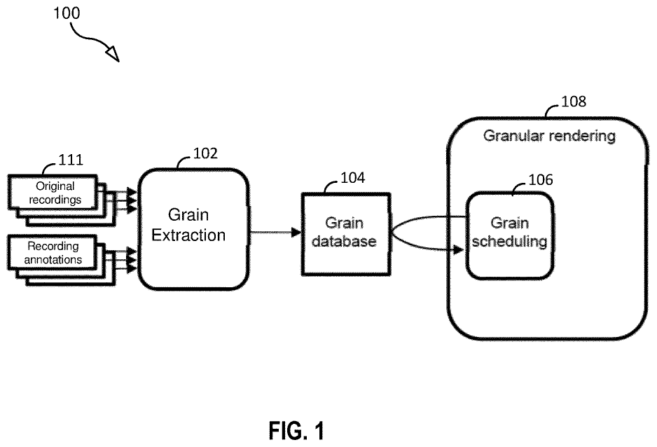

FIG. 1 illustrates a system 100 for performing granular synthesis. System 100 includes a grain extraction unit 102 which extracts grains from an original audio recording 111. For example, grain extraction unit 102 divides the original audio recording into small fragments, called “grains.” The set of extracted grains is referred to as a grain database 104. At rendering time, the grains are accessed by a grain scheduling unit 106 (a.k.a., grain selection unit), which is a component of a granular rendering unit 108. In some embodiments, there is one grain database per procedural audio source, each of which is available to the rendering unit 108. Each grain stored in grain database is associated with one or more vectors of one or more descriptor values, each vector corresponding to a particular descriptor.

When creating a grain database 104, an audio designer decides what aspects should be used as descriptors. In some cases, it might be features of the sound itself, such as, for example, pitch or loudness, but it could also be other aspects that relate to how the sound was generated, such as the speed of movement that generates a contact sound between two objects sliding against each other or the opening angle of a door that generates a screeching sound when opened and closed. The descriptors should be chosen so that the sound can be re-generated dynamically by the renderer given a target descriptor coordinate or trajectory.

As noted above, each grain stored in grain database is associated with one or more descriptor values. Accordingly, the grains of an original recording need to be annotated with the descriptor values. In the case that a descriptor is an audio feature, the descriptor value may be possible to measure directly from the audio signal itself. In other cases, the descriptor values need to be provided somehow as extra metadata of the recordings. This may be, for example, done by logging data from some sensors during the recording and providing this data in companion files. In some cases, the annotation can be done manually by creating a log of data that describes how a descriptor changes during the recording or it can be done manually for each extracted grain.

When extracting grains from an original recording, the descriptor values are stored as metadata for each grain. Using the descriptor values, each grain can be positioned in a multi-dimensioned descriptor space where the value of each descriptor describes a position along one axis within this space. If only one descriptor is used, the descriptor space is one-dimensional (1D), but if more descriptors are used the dimensionality of the descriptor space increases.

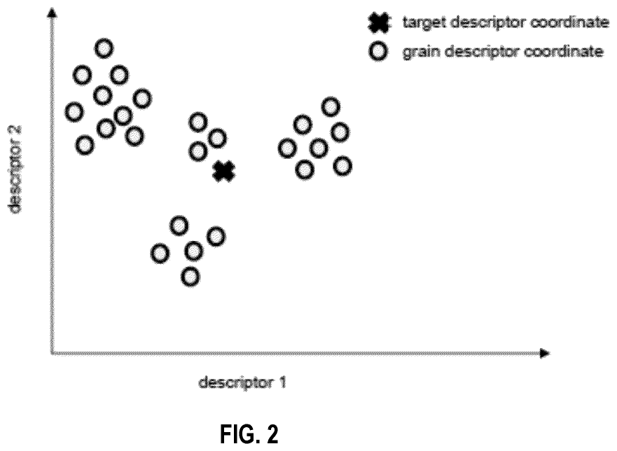

FIG. 2 shows an example two-dimensional (2D) descriptor space, where each circle represents a grain. As shown in FIG. 2, each grain has a location (e.g., a point or area) within the 2D descriptor space, this location is referred to as the grain coordinate.

The descriptor metadata for a sequence of grains extracted from one recording may describe a trajectory within the descriptor space, which corresponds to how the descriptors evolved during the original recording.

At rendering time, the scheduling of the grains (i.e., the selection of grains to render) is based on a target descriptor coordinate in the descriptor space. The target descriptor coordinate specifies what descriptor values the generated sound output should have, which means that grains close to that coordinate in the descriptor space are to be used most prominently. A target descriptor coordinate may come from many types of sources, such as a physics engine simulating the interaction of virtual bodies, live input parameters from hand controllers or other sensors, pre-defined automation parameters.

This disclosure provides a method to encode a grain database (e.g., grain database 104) where a grain segment (or segment for short), which either consists of one single grain or consists of a part of single grain, may be correlated with another segment. In many examples of grain databases, the segments have a high amount of similarity among them. For example, consider a grain database describing the sound of a car engine where each grain corresponds to the sound of one engine cycle; in such a database the neighboring grains in the descriptor space will be very similar with only minor variation. By using one such segment as a prototype for the neighboring segments, a much more compact encoded representation may result than using linear prediction or similar methods as is done by existing coding methods.

In the simplest case, one segment, Gi, can be matched with one prototype segment, Gp. A residual signal, Ri, is calculated by subtracting the signal of the prototype segment from the signal of Gi. If the lengths of the two segments are not the same, the prototype segment is truncated or zero-padded symmetrically at the start and the end. For better temporal alignment of the two segments to ensure maximal similarity and small residual, one could also apply an operation on the prototype, such as a gain factor or dynamic time warping (DTW).

The residual can then be encoded using existing methods, such as entropy coding like Huffman or RICE. The encoded representation will then include a reference of the prototype segment along with the encoded residual.

When decoding the encoded representation of a particular segment, the residual is first decoded using the corresponding decoding method (Huffman, RICE) and then the prototype segment identifier is used to obtain the prototype segment that was used to produce the encoded representation. The prototype segment is then added to the decoded residual to reconstruct the particular segment. If the prototype segment was processed with some operation at the encoding stage, this operation should be applied before the residual is calculated.

The identifier that identifies the prototype segment may be an index corresponding to specific segment in the grain database, or it could be a start and end sample index corresponding to the signal data of the segment, in the case that the signal data of all segments are stored together in one sequence of samples.

In an embodiment in which the segment is a part of a grain rather than consisting of the entire grain, the reference to the prototype segment identifies a particular grain and the relevant part of the particular grain (i.e., the part to be used as prototype). Here the part within a grain may be specified either with a start and end sample index. Alternatively, grains are divided into parts using a predetermined part size (a.k.a., subblock size) so that a part can be referenced with only one index.

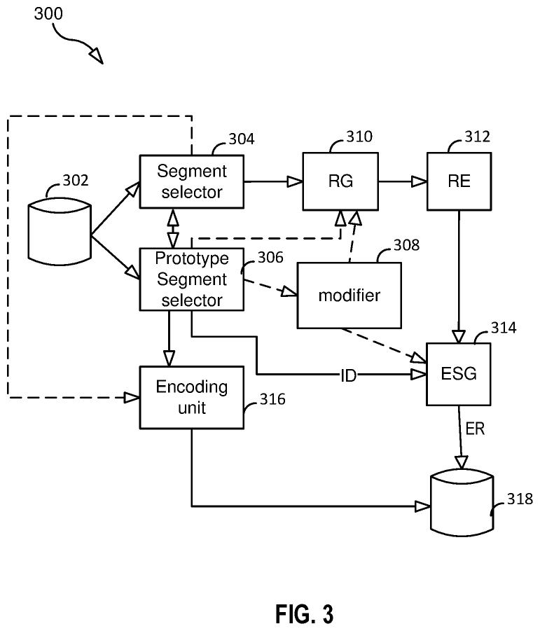

FIG. 3 illustrates a segment encoder 300, according to some embodiments. Segment encoder 300 includes a segment database 302 (e.g., grain database 104), a segment selector 304, a prototype segment selector 306, a segment modifier 308, a residual generator (RG) 310, a residual encoder (RE) 312, an encoded segment generator (ESG) 314, an encoding unit 316, and an encoded segment database 318. In one embodiment, each segment in database 302 is assigned a unique segment identifier (e.g., an index value or a start and stop time) and is either a grain or a part of a grain (hereafter “grain subblock” or “subblock” for short).

In one embodiment, encoder 300 function as described below.

Prototype segment selector 306 selects a segment from segment database 302 and provides to segment selector 304 the segment identifier for the selected segment (this segment selected by prototype segment selector 306 is referred to herein as a “prototype” segment). Using the segment identifier for the prototype segment, segment selector 304 selects from segment database 302 a segment that is “connected” to the identified prototype segment (this segment selected by segment selector 304 is referred to herein as an “original” segment). The selected original segment is then provided to residual generator 310. In one embodiment, a segment is “connected” to a prototype segment if a similarity score indicating a similarity between the segment and the prototype segment (or a modified version thereof) satisfies a condition (e.g., the similarity score meets or exceeds a threshold).

The selected prototype segment is either provided to segment modifier 308 or residual generator 310 (e.g., the prototype segment is provided to segment modifier 308 if the original segment is connected to a modified version of the prototype segment and this modified version needs to re-created). If the selected prototype segment is provided to segment modifier 308, segment modifier 308 modifies the prototype segment (e.g., performs a time shift or time-warping operation) to produce a modified prototype segment, which is then provided to residual generator 310. Residual generator 310 uses the original segment received from segment selector 304 and the received prototype segment (i.e., either the modified prototype segment received from segment modifier 308 or the unmodified prototype segment received from selector 306) to produce a residual. For example, residual generator 310 produces the residual by subtracting the prototype segment from the original segment. The residual is then received by the residual encoder 312, which encodes the residual to produce an encoded residual. The encoded residual is provided to encoded segment generator 314 which, in one embodiment, produces an encoded representation (ER) of the original segment, which, in one embodiment is a collection of information (e.g., an information element) that includes the encoded residual, segment identification information for identifying the prototype segment that was used to produce the encoded residual (e.g., a segment ID or a pointer to a segment ID), and operation information that includes one or more parameters indicating the operation(s) performed by segment modifier, if any.

Segment selector 304 then selects from database 302 another segment that is connected to the prototype segment, if such exists, and the newly selected segment will be encoded using the prototype segment as described above. If, however, there are no more segments in database 302 that are connected to the current prototype segment, then prototype segment selector 306 selects a new prototype segment from database 302, if one exists, and the above process repeats. If, however, all of the prototype segments have been selected, then all segments that are in the database but not yet encoded can be encoded using convention encoding means. At the end of the process, the result is a database of encoded segments 318.

In another embodiment, encoder 300 operates as follows. Segment selector 304 selects an original segment and then prototype segment selector 306 selects a suitable prototype segment (e.g., the segment that is most similar to the original segment unless the original segment was selected to encode the segment to avoid the case where two segments depend on each other), if any, that will be used to encode the selected original segment. That is, assuming a suitable prototype segment exists, then the residual is formed from the prototype segment (or a modified version of the prototype segment) as described above. If no suitable prototype segment exists, then the original segment is encoded using a conventional method. This process repeats until all segments are encoded. At the end of the process, the result is a database of encoded segments 318, i.e., for each segment in database 302 there is an encoded representation of that segment in database 318.

Each encoded representation of a segment in database 318 may be associated with a set of metadata (e.g., the above described descriptor values). For example, if a segment in database 302 is a grain that is associated with a set of descriptor values, then the encoded representation of the grain is associated with said set of descriptor values. As another example, if a segment in database 302 is a subblock of a grain that is associated with a set of descriptor values, then the encoded representation of the grain is associated with said set of descriptor values. Additionally, it is possible that one or more non-prototype segments are not residually encoded. Accordingly, these non-prototype segments are also provided to encoding unit 316 for encoding, which produces an encoded representation (ER) of the segment, which encoded representation includes the encoded segment and is stored in database 318. Unlike the ERs produced by ESG 314, the ERs generated by encoding unit 316 will not include an encoded residual and, hence, will not include prototype identifying information because encoding unit 316 does not use a prototype segment when encoding a segment. An ER generated by encoding unit 316, however, may include other metadata, such as, for example, information indicating parameters values used by encoding unit 316 when encoding the segment.

In either embodiment above, at least one prototype segment is not residually encoded. Accordingly, segment encoder 300 may include an encoding unit 316 for encoding the prototype segments that have not been residually encoded. The encoded prototype segments are added to database 318. Encoding unit 316 may be a conventional lossless encoder.

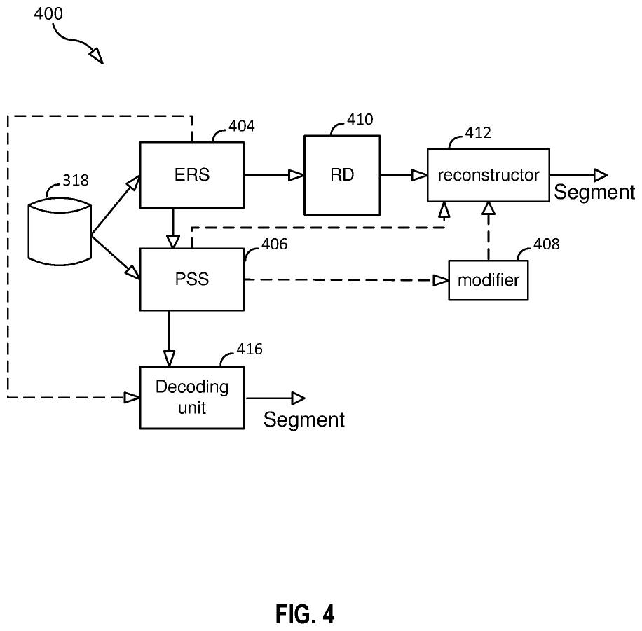

FIG. 4 illustrates a segment decoder 400, according to some embodiments. Segment decoder 400 includes an encoded segment database 318, an encoded representation selector (ERS) 404, a prototype segment selector (PSS) 406, a segment modifier 408, a residual decoder (RD) 410, a segment re-constructor 412, and a decoding unit 416. In one embodiment, segment decoder 400 function as described below. ERS 404 selects an ER from database 318. If the ER includes an encoded residual and prototype segment identification information, then ERS provides the encoded residual to RD 410 and provides the prototype segment ID information to PSS 406. If the ER also includes operation information indicating one or more operations, then the operation information is also provided to PSS 406. If the ER selected by ERS 404 does not include an encoded residual, but rather an encoded segment, then ERS 406 provides the encoded segment to decoding unit 416, which decodes the segment. RD 410 decodes the encoded residual to produce a reconstructed residual, which is provided to re-constructor 412. PSS 406 uses the prototype segment ID information to obtain the identified prototype segment. If PSS 406 received the operation information, then PSS 406 provides the prototype segment and operation information to modifier 408, which modifies the prototype segment based on the operation information and provides the modified prototype segment to re-constructor, otherwise PSS 406 provides the prototype segment to re-constructor 412. Re-constructor 412 reconstructs the original segment using the reconstructed residual and the prototype segment or modified prototype segment.

### Operations on Prototype Segments

For a prototype segment to better correlate with an original segment, the prototype segment may need to be modified. Accordingly, prototype segment selector 306 may provide a selected prototype segment to segment modifier 308, which then may perform one or more of the following operations on the selected prototype segment: (i) time shift operation where the prototype segment is shifted forward or back; (ii) a gain factor where the prototype segment is multiplied by a factor, (iii) time-stretching, where the length of the prototype segment is changed by time-stretching, and/or (iv) dynamic time warping (DTW) algorithm for the optimal alignment between the prototype segment and the original segment.

As noted above, if an operation done to a prototype segment, information about this operation is stored in the encoded representation of the original segment.

In the case of a time shift operation, the encoded representation contains information that tells the decoder that a time shift operation should be performed on the prototype segment and an index indicating how many samples it should be shifted.

In the case of the gain factor operation, the encoded representation contains information that tells the decoder that a gain factor operation should be performed on the prototype segment, and the gain factor to apply.

In the case of a time-stretching operation, the encoded representation contains information that tells the decoder that a time-stretching operation should be performed on the prototype segment and an index indicating the length that the segment should have after the time-stretch.

In the case of dynamic time warping, the encoded representation contains a series of ordered pair of indices or frame numbers between the prototype segment and the encoded segment that constitutes matched sequence.

### Selecting an Original Segment for a Given Prototype Segment

To identify a suitable original segment for a given prototype segment it is useful to determine, for each pair of segments, a similarity score that indicate the degree of similarity between the segments that make up the pair. Different approaches can be used to measure the similarity of segments. Similarity scores are generally distance measures between features in the audio signal-MFCC, spectral centroid etc. Other similarity scores could be based on sample level proximity such as dynamic time warping (DTW). The choice of a similarity score can be left to the audio designer/database creator or a brute-force method in the encoder that tries out several similarity scores and chooses the one with maximum benefit i.e., high compression rate.

In one embodiment candidate prototype segments for a given original segment are evaluated by producing residuals (e.g., subtracting candidate prototype segment from the original segment) and measuring the energy of the resulting residual. The candidate prototype segment that produces the residual having the lowest (or low enough) residual energy can be selected as the prototype segment for the given original segment.

In one embodiment, the similarity between two segments is evaluated using cross-correlation, where a high cross-correlation would mean that a segment may be useful as a prototype. One benefit of measuring the cross-correlation is that the optimal time shift can be identified.

Different operations can be evaluated for a potential prototype segment to optimize the similarity between the segments, e.g., by applying a gain or shift operation.

Ideally, prototype segments should be selected only where they help to reduce the bitrate (i.e., size) of the encoded representation. In some cases, several segments can share the same prototype, which is extra beneficial. An encoder can therefor work to identify clusters of segments that can share the same prototype segment. In these cases, selecting one shared prototype may be better than using several prototypes that more closely resemble the segments they are prototypes for.

### Example Prototype Segment Selection Method

A method for selecting a prototype segment is detailed below. Instead of using a prototype segment for encoding a single segment, it is efficient to use a prototype segment to encode more than one segment.

To find a set of one or more prototype segments where at least one of the prototype segments in the set can be used to encode more than one segment, one could construct a graph where each node of the graph is represented by a segment. The edges between two segments in the graph are indicative of the similarity between that pair of segments. The edges could be weighted with the weight directly proportional to the similarity score between the two segments. If the weight for an edge is below a threshold, then the edge may be removed from the graph.

After removal of edges from the graph, if any, then, any segment with a large enough number of edges (i.e., a number of connections greater than a threshold) can be considered to be influential and used as a prototype segment. The segments connected to a prototype segment can then be encoded using this prototype segment.

Accordingly, in one embodiment, the following steps may be performed:
1) for each segment in the segment database, pair the segment with another segment in the segment database and/or one or more modified versions of the another segment and, for each said pair, compute a similarity score indicating the similarity between the two segments that make up said pair (an example of similarity score is correlation). With N segments in the database, the computed scores can be arranged in one or more N×N matrices. For example, if each segment is compared with each other segment to produce a similarity score for each said pair and if each segment is further compared with a modified version of each other segment to produce a similarity score for each said pair, then there will be two N×N matrices. In one embodiment, the highest similarity score, after all comparisons between two segments with and without modifications is used to determine the connection between segments.
2) chose a similarity threshold;
3) for each pair of segments, determine whether the similarity score for the pair satisfies a condition based on the similarity threshold and if the score satisfies the condition, then “connect” the segments that form the pair (e.g., connect each pair where the score for the pair exceeds the similarity threshold);
4) for each segment, determine the total number of other segments to which the segment is connected (i.e., for each segment, determines the segment's degree of centrality);
5) set a prototype threshold;
6) for each segment, determine whether the segment's degree of centrality satisfies a condition based on the prototype threshold, and, if the segment's degree of centrality satisfies the condition, then classify the segment as a prototype segment (i.e., include the segment in a set of candidate prototype segments);
7) select from the set of candidate prototype segments, the candidate prototype segment having the highest degree of centrality;
8) use the selected prototype segment to encode each segment connected to the selected prototype segment that has not already been encoded (e.g., for each segment connected to the selected prototype segment, create the above described residual if the residual has not yet been created);
9) remove the selected prototype segment from the set of candidate prototype segments;
10) if not all segments in the database have been encoded and if there remains at least one candidate segment that has not yet been selected, then repeat the process beginning at step 7) (i.e., select a new prototype segment), otherwise proceed to the next step; and 11) if all segments have been ended, the process ends, but if there remain segments that are standalone (i.e., have not been encoded), then these remaining segments are encoded separately without the use of a prototype segment (e.g., encoded using conventional lossless encoding).

### Limiting Similarity Search by Distance in the Descriptor Space

In order to limit the number of comparisons in the selection of prototype grains, the search for potential prototype grains can be limited to grains that are close to each other in the descriptor space. The assumption is that grains that are close in the descriptor space are more similar than grains that are far apart. By limiting the number of comparisons needed, the speed of the encoding process can be increased. One way to do this is to set a limit on the Euclidian distance between two grains in the descriptor space. If the distance is above the threshold, the comparison is skipped, the similarity score set to 0, and no connection is set between the grains.

### Duplicated Data for Overlap Regions of Grains

In some embodiments, each grain in the grain database needs to be stored along with some extra signal data before the start and after the end of the grain. This data is used for the cross-fade of grain when performing overlap-add during the rendering. Many times, these cross-fade regions of grains are duplicated. This happens when two grains are extracted from adjacent segments of the same recording. This means that one or both cross-fade regions of a grain may be duplicated in other grains. However, the cross-fade region at the start of the grain and at the end of the grain will not appear in the same grain, they will always be found in different grains.

To exploit this duplication of data, a grain can be divided into two subblocks where one subblock contains the cross-fade region and the other contains the remainder of the grain. In such a scenario, the above described segments contain only one subblock of a grain. It is known that if there is a duplication of the cross-fade region at the start of a grain, it will be found at the end of another grain. Vice versa, the duplication of the cross-fade region at the end of a grain will be found at the start of another grain. By using a reference to a prototype grain and a start and end index, a prototype subblock can be specified.

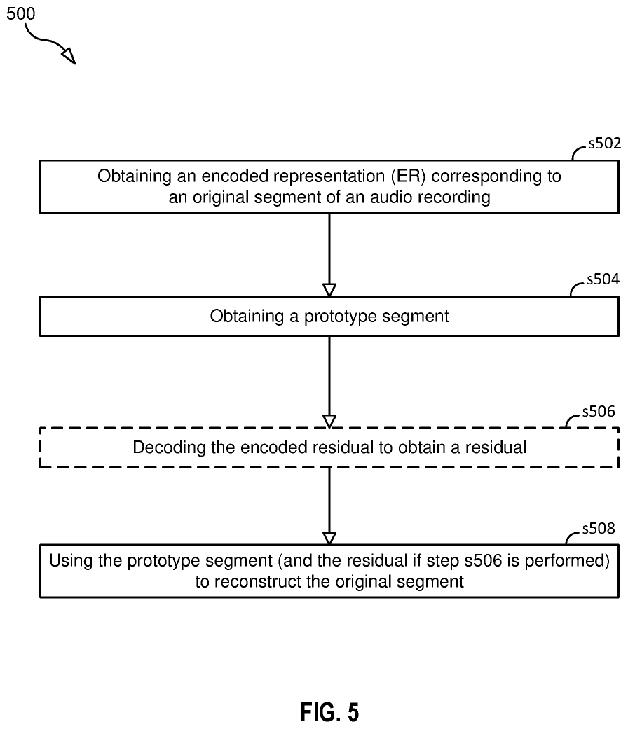

FIG. 5 is a flow chart illustrating a process 500, according to an embodiment, for decoding audio segments. Process 500 may begin in step s502.

Step s502 comprises obtaining an encoded representation (ER) corresponding to an original segment of an audio recording. The ER may include an encoded residual that was generated using a prototype segment, and, in this embodiment, the ER comprises a prototype segment identifier.

Step s504 comprises obtaining a prototype segment. In this embodiment, obtaining the prototype segment comprises using the prototype segment identifier to retrieve the prototype segment.

Step s506 (optional) comprises decoding the encoded residual to obtain a residual.

Step s508 comprise reconstruct the original segment using the prototype segment, and also using the residual in the case that step s506 is performed.

In one embodiment, using the prototype segment to reconstruct the original segment comprises: modifying the prototype segment to produce a modified prototype segment; and using the modified prototype segment to reconstruct the original segment. In one embodiment, the ER further comprises operation information indicating one or more operations, and modifying the prototype segment comprises modifying the prototype segment based on the indicated operations.

In one embodiment, the original segment consists of a grain of an audio recording, and the grain is associated with a grain coordinate that identifies a location of the grain in an N-dimensional descriptor space.

In one embodiment, the original segment consists of a subblock of grain of an audio recording, and the grain is associated with a grain coordinate that identifies a location of the grain in an N-dimensional descriptor space.

In one embodiment, the subblock consists of a cross-fade region.

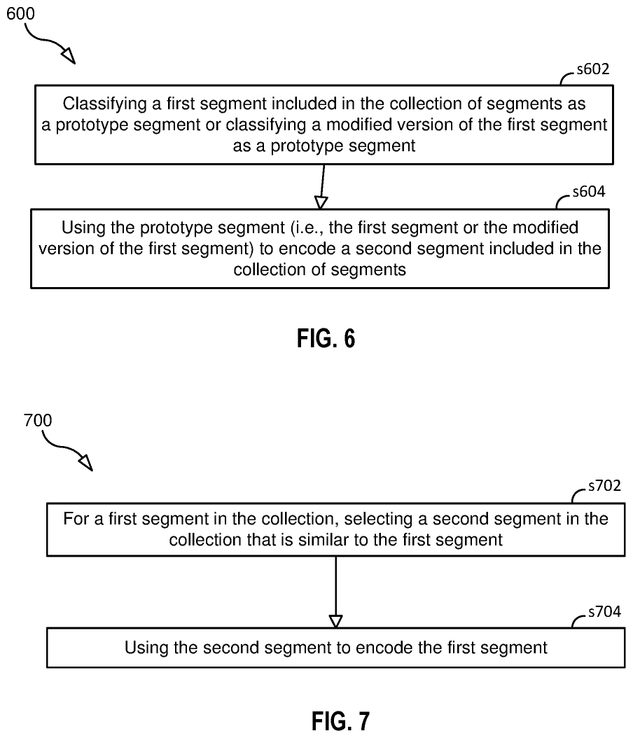

FIG. 6 is a flow chart illustrating a process 600, according to an embodiment, for encoding segments of an audio recording included in a collection of segments. Process 600 may begin in step s602. Step s602 comprises classifying a first segment included in the collection of segments as a prototype segment or classifying a modified version of the first segment as a prototype segment. Step s604 comprises using the prototype segment (i.e., the first segment or the modified version of the first segment) to encode a second segment included in the collection of segments.

In some embodiments, classifying the first segment as a prototype segment comprises: determining a similarity score indicating a similarity between the first segment and the second segment; determining that the similarity score satisfies a condition based on a similarity threshold; as a result of determining that the similarity score satisfies the condition, incrementing a counter value associated with the first segment; and determining whether to classify the first segment as a prototype segment based on the counter value.

In some embodiments, classifying the modified version of the first segment as a prototype segment comprises: determining a similarity score indicating a similarity between the modified version of the first segment and the second segment; determining that the similarity score satisfies a condition based on a similarity threshold; as a result of determining that the similarity score satisfies the condition, incrementing a counter value associated with the modified version of the first segment; and determining whether to classify the modified version of the first segment as a prototype segment based on the counter value.

FIG. 7 is a flow chart illustrating a process 700, according to an embodiment, for encoding segments of an audio recording included in a collection of segments. Process 700 may begin in step s702. Step s702 comprises, for a first segment in the collection, selecting a second segment in the collection that is similar to the first segment (e.g., comparing the first segment to each other segment in the collection to determine which one of the other segments is most similar to the first segment). Step s704 comprises using the second segment to encode the first segment.

In some embodiments, process 700 also includes selecting a third segment in the collection that is similar to the second segment; using the third segment to encode the second segment.

In some embodiments, the process 700 further comprises calculating a first similarity score which indicates a degree of similarity between the first segment and the second segment and calculating a second similarity score which indicates a degree of similarity between the first segment and the third segment, and selecting the second segment comprises: i) comparing the first similarity score to the second similarity score to determine whether or not the similarity between the first segment and the second segment is greater than the similarity between the first segment and the third segment, and ii) selecting the second segment as a result of determining that the similarity between the first segment and the second segment is greater than the similarity between the first segment and the third segment.

In some embodiments, the process 700 further comprises: calculating a first similarity score which indicates a degree of similarity between the first segment and the second segment; calculating a second similarity score which indicates a degree of similarity between the first segment and a modified version of the second segment; calculating a third similarity score which indicates a degree of similarity between the first segment and the third segment; and calculating a fourth similarity score which indicates a degree of similarity between the first segment and a modified version of the third segment, and selecting the second segment comprises selecting the second segment based on either the first or second similarity score.

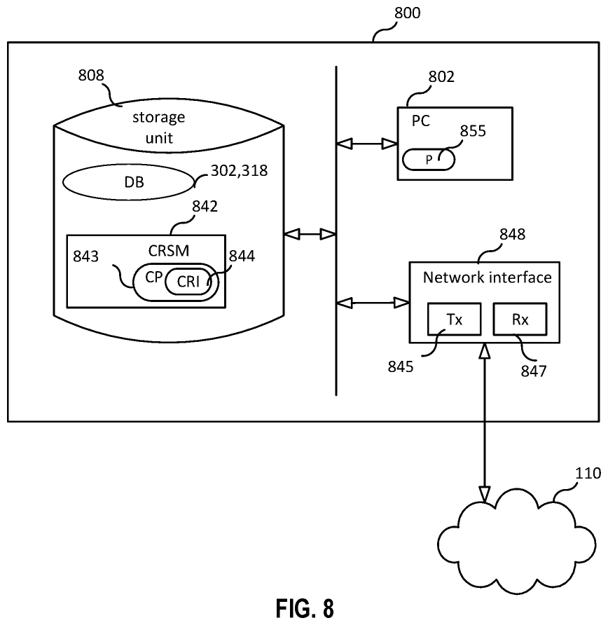

FIG. 8 is a block diagram of an apparatus 800, according to some embodiments, for performing the methods disclosed herein. For instance, apparatus 800 can be configured to perform the segment encoding and/or segment decoding method disclosed herein. When apparatus 800 is configured to perform a segment encoding method, apparatus 800 may be referred to as encoding apparatus 800, and when apparatus 800 is configured to perform a segment decoding method, apparatus 800 may be referred to as decoding apparatus 800.

As shown in FIG. 8, apparatus 800 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 800 may be a distributed computing apparatus); at least one network interface 848 (e.g., a physical interface or air interface) comprising a transmitter (Tx) 845 and a receiver (Rx) 847 for enabling apparatus 800 to transmit data to and receive data from other nodes connected to a network 110 (e.g., an Internet Protocol (IP) network) to which network interface 848 is connected (physically or wirelessly) (e.g., network interface 848 may be coupled to an antenna arrangement comprising one or more antennas for enabling apparatus 800 to wirelessly transmit/receive data); and a storage unit (a.k.a., “data storage system”) 808, which may include one or more non-volatile storage devices and/or one or more volatile storage devices (as illustrated in FIG. 8, database (DB) 302 and/or DB 318 may be stored in storage unit 808). In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes apparatus 800 to perform steps described herein (e.g., steps described herein with reference to the flow charts). In other embodiments, apparatus 800 may be configured to perform steps described herein without the need for code. That is, for example, PC 802 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. Further, as used herein “a” means “at least one” or “one or more.”

### REFERENCES

[1] US20180068487A1: Systems and methods for simulating sounds of a virtual object using procedural audio (Disney Enterprises Inc.).
[2] Farnell, Andy, “An introduction to procedural audio and its application in computer games,” Audio mostly conference Vol. 23. 2007.
[3] D. Gabor, “Theory of communication. Part 1: The analysis of information,” Journal of the Institution of Electrical Engineers-Part III: Radio and Communication Engineering, vol. 93, no. 26, pp. 429-441, 1946.
[4] D. Schwarz, “Corpus-Based Concatenative Synthesis,” in IEEE Signal Processing Magazine, vol. 24, no. 2, pp. 92-104, March 2007, doi: 10.1109/MSP.2007.323274.
[5] D. Schwarz “Distance mapping for corpus-based concatenative synthesis.” Sound and Music Computing (SMC) 2011.
[6] Aaron Einbond and Diemo Schwarz. “Spatializing timbre with corpus-based concatenative synthesis.” International Computer Music Conference Proceedings. Vol. 2010. International Computer Music Association, 2010.
[7] D. Schwarz. “A system for data-driven concatenative sound synthesis.” Digital Audio Effects (DAFx). 2000.
[8] D. Schwarz et al. “Real-time corpus-based concatenative synthesis with catart.” 9th International Conference on Digital Audio Effects (DAFx). 2006.
[9] Diemo Schwarz and Norbert Schnell. “Descriptor-based sound texture sampling.” Sound and music computing (SMC) 2010.
[10] Diemo Schwarz and Sean O'Leary. “Smooth granular sound texture synthesis by control of timbral similarity.” Sound and Music Computing (SMC) 2015.
[11] Yu, R., Geiger, R., Rahardja, S., Herre, J., Lin, X., & Huang, H. (2004, October). “MPEG-4 scalable to lossless audio coding”. In Proc. 117th AES Conv (pp. 1-14).
[12] Zechen Zhang, Nikunj Raghuvanshi, John Snyder, and Steve Marschner. 2019. Acoustic texture rendering for extended sources in complex scenes. ACM Trans. Graph. 38, 6, Article 222 (December 2019), 9 pages. https://doi.org/10.1145/3355089.3356566.
[13] Barrass, Stephen, and Matt Adcock. “Interactive granular synthesis of haptic contact sounds.” Audio Engineering Society conference: 22nd international conference: virtual, synthetic, and entertainment audio. Audio Engineering Society, 2002.
[14] US20190094975A1: Haptic Effect Conversion System Using Granular Synthesis: Immersion Corp.

1. A method for decoding audio segments, the method comprising:
obtaining an encoded representation, (ER) corresponding to an original segment of an audio recording, wherein the ER comprises a prototype segment identifier;
obtaining a prototype segment, wherein obtaining the prototype segment comprises using the prototype segment identifier to retrieve the prototype segment; and
using the prototype segment to reconstruct the original segment.

2. The method of claim 1, wherein
the ER comprises an encoded residual,
the method further comprises decoding the encoded residual to obtain a residual, and
the original segment is reconstructed using the residual and the prototype segment.

3. The method of claim 1, wherein using the prototype segment to reconstruct the original segment comprises:
modifying the prototype segment to produce a modified prototype segment; and
using the modified prototype segment to reconstruct the original segment.

4. The method of claim 3, wherein
the ER further comprises operation information indicating one or more operations, and
modifying the prototype segment comprises modifying the prototype segment based on the indicated operations.

5. The method of claim 1, wherein
the original segment consists of a grain of an audio recording, and
the grain is associated with a grain coordinate that identifies a location of the grain in an N-dimensional descriptor space.

6. The method of claim 1, wherein
the original segment consists of a subblock of grain of an audio recording, and
the grain is associated with a grain coordinate that identifies a location of the grain in an N-dimensional descriptor space.

7. The method of claim 6, wherein the subblock consists of a cross-fade region.

8. A method for encoding segments of an audio recording included in a collection of segments, the method comprising:
classifying a first segment included in the collection of segments as a prototype segment or classifying a modified version of the first segment as a prototype segment; and
using the prototype segment to encode a second segment included in the collection of segments.

9. The method of claim 8, wherein classifying the first segment as a prototype segment comprises:
determining a similarity score indicating a similarity between the first segment and the second segment;
determining that the similarity score satisfies a condition based on a similarity threshold;
as a result of determining that the similarity score satisfies the condition, incrementing a counter value associated with the first segment; and
determining whether to classify the first segment as a prototype segment based on the counter value.

10. The method of claim 8, wherein classifying the modified version of the first segment as a prototype segment comprises:
determining a similarity score indicating a similarity between the modified version of the first segment and the second segment;
determining that the similarity score satisfies a condition based on a similarity threshold;
as a result of determining that the similarity score satisfies the condition, incrementing a counter value associated with the modified version of the first segment; and
determining whether to classify the modified version of the first segment as a prototype segment based on the counter value.

11. A method for encoding segments of an audio recording included in a collection of segments, the method comprising:
for a first segment in the collection, selecting a second segment in the collection that is similar to the first segment; and
using the second segment to encode the first segment.

12. The method of claim 11, further comprising:
selecting a third segment in the collection that is similar to the second segment; and
using the third segment to encode the second segment.

13. The method of claim 12, wherein
the method further comprises calculating a first similarity score which indicates a degree of similarity between the first segment and the second segment and calculating a second similarity score which indicates a degree of similarity between the first segment and the third segment, and
selecting the second segment comprises:
i) comparing the first similarity score to the second similarity score to determine whether or not the similarity between the first segment and the second segment is greater than the similarity between the first segment and the third segment, and
ii) selecting the second segment as a result of determining that the similarity between the first segment and the second segment is greater than the similarity between the first segment and the third segment.

14. The method of claim 12, wherein
the method further comprises:
calculating a first similarity score which indicates a degree of similarity between the first segment and the second segment;
calculating a second similarity score which indicates a degree of similarity between the first segment and a modified version of the second segment;
calculating a third similarity score which indicates a degree of similarity between the first segment and the third segment; and
calculating a fourth similarity score which indicates a degree of similarity between the first segment and a modified version of the third segment, and
selecting the second segment comprises selecting the second segment based on either the first or second similarity score.

15. A computer program comprising instructions which when executed by processing circuitry of an apparatus causes the apparatus to perform the method of claim 1.

16. (canceled)

17. An apparatus for decoding audio segments, the apparatus being configured to perform a method comprising:
obtaining an encoded representation, (ER) corresponding to an original segment of an audio recording, wherein the ER comprises a prototype segment identifier;
obtaining a prototype segment, wherein obtaining the prototype segment comprises using the prototype segment identifier to retrieve the prototype segment; and
using the prototype segment to reconstruct the original segment.

18. The apparatus of claim 17, wherein
the ER comprises an encoded residual,
the method further comprises decoding the encoded residual to obtain a residual, and
the original segment is reconstructed using the residual and the prototype segment.

19. An apparatus for encoding segments of an audio recording included in a collection of segments, the apparatus being configured to perform a method comprising:
classifying a first segment included in the collection of segments as a prototype segment or classifying a modified version of the first segment as a prototype segment; and
using the prototype segment to encode a second segment included in the collection of segments.

20. The apparatus of claim 19, wherein classifying the first segment as a prototype segment comprises:
determining a similarity score indicating a similarity between the first segment and the second segment;
determining that the similarity score satisfies a condition based on a similarity threshold;
as a result of determining that the similarity score satisfies the condition, incrementing a counter value associated with the first segment; and
determining whether to classify the first segment as a prototype segment based on the counter value.

21-23. (canceled)
